(19) United States
(12) Patent Application Publication
(10) Pub. No.: US 2012/0027058 A1
(43) Pub. Date: Feb. 2, 2012

(54) PORTABLE, WIRELESS MULTI-CHANNEL IMPEDANCE ANALYZER

(75) Inventors: Jerome P. Lynch, Ann Arbor, MI (US); Erik Alexander Jarva, Redondo Beach, CA (US); Sukhoon Pyo, Ann Arbor, MI (US)

(73) Assignee: THE REGENTS OF THE UNIVERSITY OF MICHIGAN, Ann Arbor, MI (US)

(21) Appl. No.: 13/192,721

(22) Filed: Jul. 28, 2011

Related U.S. Application Data
(60) Provisional application No. 61/368,682, filed on Jul. 29, 2010.

(51) Int. Cl. H04B 1/38

(52) U.S. Cl. 375/219

(57) ABSTRACT

An improved portable wireless impedance analyzer is provided. The impedance analyzer is comprised of: a wireless transceiver configured to receive user commands; a direct digital synthesizer operable to generate an injection signal in accordance with the input parameters; and a microcontroller interfaced with the wireless transceiver and the direct digital synthesizer. The microcontroller translates the user commands from the wireless transceiver into one or more input parameters for the direct digital synthesizer and communicates the input parameters to the direct digital synthesizer.

### CROSS-REFERENCE TO RELATED APPLICATIONS

This application claims the benefit and priority of U.S. Provisional Application No. 61/368,682 filed Jul. 29, 2010. The entire disclosure of the above application is incorporated herein by reference.

### GOVERNMENT INTEREST

This invention was made with government support under CCMI0846256 awarded by the National Science Foundation and 70NANB9H9008 awarded by the National Institute of Standards and Technology. The government has certain rights in the invention.

### FIELD

The present disclosure relates to an improved portable wireless impedance analyzer which may be used for structural health monitoring, material characterization as well as other applications.

### BACKGROUND

The United States bridge inventory is rapidly aging with 20% of the nation's bridges currently exceeding their intended 50-year design lives; within the next 15 years, it is estimated this number will exceed 50% (AASHTO 2008). Structural aging is followed by deterioration and the need for more vigilant structural management. In addition to bridges, many other critical infrastructure systems are also rapidly aging with significant deterioration reported. Current structural health management methods are based on visual inspection with the inspector looking for visual cues that may indicate structural distress. While visual inspection is the primary tool for assessing the health of many complex structural systems such as aircrafts, ships, and bridges, such methods are known to suffer from a number of limitations. Specifically, visual inspection is labor-intensive and can be highly subjective. To overcome these limitations, researches in the field of structural health monitoring (SHM) are developing methods for the autonomous identification of deterioration and damage in structural systems using permanently installed sensing systems.

Within the SHM field, a particular emphasis has been placed on the development of new sensors that offer lower costs, reduced from factors, and greater functionality. Among the many technological developments in the realm of sensors, most notable are the new materials developed for sensing and actuating structures. In particular, piezoelectric transducers such as lean zirconate titanate (PZT) have been extensively studied for SHM applications due to their ability to be used as a sensor or actuator. For example, the electro-mechanical impedance of a PZT patch mounted to a host structure can be used to detect structural damage. The basic concept of the impedance-based method is that damage in a structure could be detected by monitoring structural impedance in a local area using high-frequency vibration. Alternative SHM approaches based on the controlled introduction of high-frequency elastic stress waves in thin plate structural elements (i.e. Lamb waves) have also been illustrated using PZT pads. In addition to successful results derived in the laboratory, PZT-based sensing for SHM is also beginning to find its way to practical settings. For example, PZT-based active damage detection techniques for nondestructive evaluation of operational steel bridges have been reported.

Other engineered materials under development for SHM include multifunctional, self-sensing materials that possess electrical properties that are linked to the mechanical and physical properties of the material. Among the many multifunctional materials under development, carbon nanotube composites have garnered significant research attention in recent years. Single- and multi-walled carbon nanotubes (SWNT and MWNT, respectively) have been reported in the literature. Due to their impressive mechanical and physical properties (e.g., high tensile strength, high elastic modulus, and large surface area), the SHM community has explored the inclusion of SWNTs in polymer matrices to create conformable thin-film sensors for measuring strain and pH. The inclusion of SWNTs in the polymer matrix modifies the bulk conductivity of the composite while simultaneously reinforcing the composite to achieve high tensile strength and stiffness.

A distinct advantage of multifunctional materials used for sensing within SHM systems is their ability to essentially achieve a sensor measurement everywhere the material is. This creates the opportunity to deviate from the traditional point-bases sensing strategies universally used in SHM systems (i.e., the use of sensors that take localized measurements at a specific point in the structure). Similar to dermatological systems found in animals, an engineered “sensing skin” possessing transduction mechanisms throughout its area and deposited on the surface of a structure can serve as a platform for spatial structural sensing. Using a controlled electrical stimulation and a corresponding set of voltage measurements taken at the skin boundary, two-dimensional (2D) maps of the skin's electrical conductivity can be derived through the use of the electrical impedance tomography (EIT) technique. Since thin film conductivity is calibrated to an applied external stimulus such as strain or pH, conductivity mapping by EIT will yield a corresponding 2D structural damage map. However, due to the complexity of the inverse-problem that EIT solves, the data acquisition requirements of EIT can be challenging to achieve. Specifically, EIT requires a large number of electrodes mounted to the boundary of the skin, precise control of the direct and alternating current (DC and AC, respectively) excitation, and repeated injection of electrical current on many different electrode pairs.

A powerful but low-cost approach to EIT data acquisition is proposed herein for bio-inspired thin-film sensing skins. A wireless impedance analyzer is designed such that any of its 32 channels can output an electrical current with a user-prescribed frequency, mean, and amplitude, while the remaining multiplexed channels can measure boundary voltage using an onboard analog-to-digital converter. Upon data acquisition, an onboard microcontroller provides ample computational resources for calculating electrical impedance (a complex-valued material property) from the input/output electrical measurements. Finally, a wireless transceiver is integrated to free the system from its dependence on coaxial wiring for the communication of electrical impedance data. This portable, low-cost wireless impedance analyzer is unique in its design when compared to other wireless impedance analyzers previously proposed for PZT-based SHM. First, the analyzer proposed in this study supports a large number of channels that are necessary for EIT; in contrast, previously proposed wireless impedance analyzers have a limited number of channels (e.g., eight or fewer channels). The wireless impedance analyzer in this study also has a flexible current generation unit not found in other systems that have relied on a commercial impedance measurement integrated circuit (i.e., Analog Devices AD5933). The current generation unit used in the proposed wireless impedance analyzer allows the user to define the electrical current, whereas analyzers based on the AD5933 hide this functionality from the user and only reports measured electrical impedance. Moreover, the impedance analyzer is designed to be small and portable, thereby extending the use of EIT to thin-film sensing skins and many other applications.

This section provides background information related to the present disclosure which is not necessarily prior art.

### SUMMARY

An improved portable wireless impedance analyzer is designed for impedance measurements and the acquisition of electrical impedance spectroscopy and electrical impedance tomography data. The impedance analyzer is comprised of: a wireless transceiver configured to receive user commands and to transmit data back to the user; a direct digital synthesizer operable to generate an injection signal in accordance with the input parameters; and a microcontroller interfaced with the wireless transceiver and the direct digital synthesizer. The microcontroller translates user commands into one or more input parameters for the direct digital synthesizer and communicates the input parameters to the direct digital synthesizer.

In one aspect of the disclosure, the amplitude, frequency, and mean of the injection signal is set via the user commands by an operator of the impedance analyzer.

In another aspect of the disclosure, the impedance analyzer selectively outputs the injection signal to any one of a plurality of addressable output channels while sampling the resulting voltage at a plurality of input channels.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

FIG. 1 is a functional block diagram of a wireless impedance analyzer;

FIG. 2 depicts an exemplary data acquisition scheme for electrical impedance tomography in a sensing skin application;

FIGS. 3A and 3B are schematics illustrating two validation experiments;

FIGS. 4A-4C are graphs illustrating measured voltages from an injection current having frequency 1, 5 and 10 Hertz, respectively;

FIGS. 5A and 5B are graphs illustrating electrical impedance spectroscopy of an RC circuit as measured by the impedance analyzer;

FIG. 6 is a schematic showing the sensing skin deposited on a primer-coated carbon steel substrate; and

FIG. 7 is a graph illustrating the average conductivity at each well plotted as a function of corrosion time.

The drawings described herein are for illustrative purposes only of selected embodiments and not all possible implementations, and are not intended to limit the scope of the present disclosure. Corresponding reference numerals indicate corresponding parts throughout the several views of the drawings.

### DETAILED DESCRIPTION

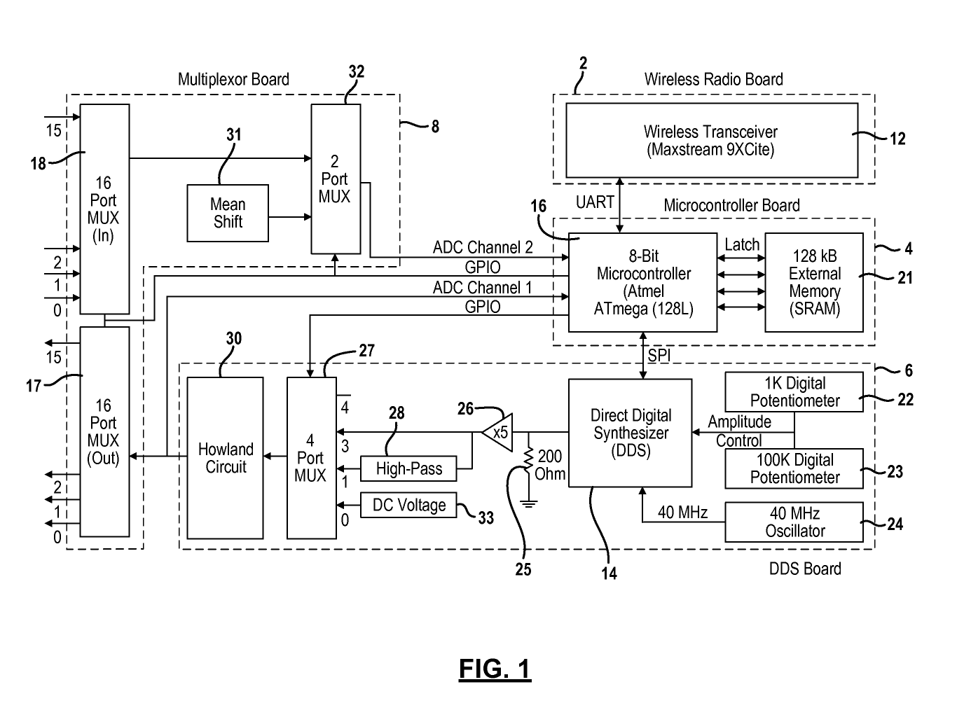

FIG. 1 depicts an exemplary embodiment of a portable wireless impedance analyzer 10 designed for automated impedance measurements and acquisitions of EIT data. The impedance analyzer 10 is comprised generally of: a wireless transceiver 12, a direct digital synthesizer 14 (DDS), a microcontroller 16 and one or more multiplexers 17, 18. It is understood that the primary components are noted, but other system components (some of which are further described below) may be needed to control and manage the overall operation of the impedance analyzer.

In operation, the wireless transceiver 12 is configured to receive commands that specify operational parameters for the analyzer. Commands are in turn passed from the wireless transceiver 12 to the microcontroller 16. The microcontroller 16 will parse the commands to extract operating parameters for the analyzer. Exemplary parameters may include an amplitude, mean, phase or frequency for an injection current as well as other parameters for operating the analyzer. Operation of the analyzer is controlled by the microcontroller in accordance with the received operating parameters.

For example, the microcontroller 16 translates the operating parameters received from user commands into one or more input parameters for the direct digital synthesizer 14 and sets the input parameters of the direct digital synthesizer 14 accordingly. The direct digital synthesizer 14 generates an injection current in accordance with the input parameters and outputs the injection current to an output multiplexer 17. The output multiplexer 17 has a plurality of output pins, each pin is coupled to a port of the analyzer. The microcontroller 16 interfaces with the multiplexer 17 to select one of the pins from which to output the injection current into a measurement subject.

Voltage measures from the subject are collected using an input multiplexer 18. The input multiplexer 18 has a plurality of input pins for receiving voltage measures, each pin is coupled to a port of the analyzer. In an exemplary embodiment, each port of the analyzer is coupled to an output pin of the output multiplexer 17 and to an input pin of input multiplexer 18. In this way, one set of device ports can be used as either input or output. Each multiplexer 17, 18 can be individually addressed by the microcontroller to set a given port as an input or an output. In an alternative embodiment, a separate set of input ports and output ports can have a one-to-one correspondence with the input multiplexer 18 and output multiplexer 17, respectively. The microcontroller 16 also interfaces with the input multiplexer 18 to select which port from which to receive a voltage measure at a given time. Voltage measures received at the input multiplexor 18 are output via a single output pin to the microcontroller 16. The voltage measures received at the microcontroller 16 are digitized and may be stored locally in a memory device of the analyzer and/or transmitted remotely via the wireless transceiver to another device.

The impedance analyzer 10 may be constructed using three or more separate circuit boards: a wireless radio board 2, a microcontroller board 4, a synthesizer board 6 and at least one multiplexor board 8. Each board is designated a function within the EIT data acquisition process. The microcontroller board 4 controls the overall operation of the analyzer. The synthesizer board 6 operates to generate an injection current using a direct digital synthesizer (DDS). The multiplexor board 8 selects the inputs/outputs coupled to the measurement subject. In an exemplary embodiment, the boards are connected using interlocking headers and flat flexible cables as further described below. It is understood that the impedance analyzer may be implemented using more or less circuit boards.

The microcontroller board 4 is a critical element of the wireless impedance analyzer because it is primarily responsible for the entire unit's operation. At the core of the microcontroller board is a low-power 8-bit microcontroller 16 (Atmel Atmega128) that is powered by a regulated 5 V power supply. The 5 V power supply regulates its output based on the battery power provided to the unit (7.5 V or higher). An 8 MHz crystal is included in the microcontroller board to provide a clock signal to the microcontroller. Internal to the microcontroller is 128 kB of read-only flash memory; this memory is for the storage of software used to operate the microcontroller. An additional 128 kB of static random access memory 21 (SRAM) is included in the microcontroller board design to provide memory for data storage. The peripheral services of the microcontroller are used to interface with the other circuit components, including the wireless transceiver 12 (using the universal asynchronous receiver transmitter, or UART) and the variety of multiplexors (MUX) on the direct digital synthesizer board 6 and multiplexor board 8. The internal 10-bit ADC of the microcontroller is used to collect voltage waveforms generated by the multiplexor board. The input voltage range of the microcontroller ADC is 0 to 5 V.

The direct digital synthesizer (DDS) board 6 is primarily responsible for the generation of the electrical stimulus, that is applied to the testing subject. As such, it is where the current is generated and regulated by the microcontroller for output by the multiplexor board. The main component of the DDS board is the Analog Devices AD9834 direct digital synthesizer 14 capable of outputting sinusoidal signals at frequencies as large as 75 MHz. A 40 MHz oscillator 24 is included on the DDS board to provide a clock signal to the AD9834 DDS. The DDS board is controlled by the microcontroller 16 (i.e., Atmel Atmega128) with the microcontroller communicating desired frequencies and phase shifts to the DDS via a serial peripheral interface (SPI). Using a 40 MHz reference oscillator 24, the DDS board is capable of outputting sinusoidal signals with frequencies between 0.15 Hz and 20 MHz in 0.15 Hz increments. The output signal from the AD9834, when passed over a 200Ω resistor to ground, can generate a sinusoidal voltage between 30 to 600 mV. The actual peak-to-peak amplitudes of the generated sinusoidal signal are defined by two digital potentiometers 22, 23 integrated with the DDS board that are controlled by the microcontroller 16. To amplify the output signal, a non-inverting amplifier 26 is designed using standard operational amplifiers to amplify the AD9834 signal by a factor of five.

To offer the end-user of the wireless impedance analyzer maximum flexibility, the electrical signal generated by the DDS is split into two parts. First, the sinusoidal signal whose peak-to-peak span is between 30 to 600 mV (i.e., non-zero mean) is passed to one channel of a 4-channel multiplexor 27. The other part of the split is passed through a high-pass filter 28 to remove the non-zero mean. This high-passed signal is then fed to the second channel of the multiplexor. Finally, a constant voltage is generated by dividing the 5 V references of the DDS board using a digital potentiometer for generating a user-selected voltage that is between 0 and 5 V. This DC voltage is then passed to the third channel of the multiplexor 27. The microcontroller 16 is capable of using its general purpose input/output pins to select which of the three outputs to use (i.e., AC signal with non-zero mean, AC signal with zero mean, and DC signal). The output of the multiplexor is then fed to a standard Howland voltage-current converter for output by the DDC board 6. The maximum permissible current amplitude capable by the converter 30 is a ±5 mA. The output of the Howland circuit 30 is also fed to the microcontroller ADC and sampled using the ADC's first input channel.

The multiplexor board 8 is used to output the DDS board's regulated AC or DC current while simultaneously recording the corresponding voltage response of the sensing skin. To ensure the wireless impedance analyzer can be used for electrical impedance tomography, a large number of input/output channels are desired. The multiplexor board 8 includes 16 gold plated subminiature version A (SMA) jacks to which coaxial wires (i.e., electrodes) can be attached. Internally, the multiplexor board includes four 8-channel multiplexing integrated circuit chips. Two of the 8-channel multiplexors are used to route the DDS current to any of the board's 16 electrodes as selected by the microcontroller 16 using the multiplexors' select bits. The other two multiplexors are used to feed the microcontroller 16 using the multiplexors' select bits. The other two multiplexors are used to feed the same 16 SMA electrode connections to the microcontroller's 10-bit ADC for sampling. Again, select bits on the multiplexors are used by the microcontroller to select which electrode it will collect data from using its ADC. The voltage signal from the multiplexor board is input to the second input channel of the ADC. If the sensing skin is stimulated by the DDC board with non-zero mean AC or DC inputs, the recorded voltages will fall within the ADC's 0 to 5 V input range. However, if the zero mean AC input is applied to the testing subject, the voltage generated by the sensing skin will also have a zero mean. Hence, a voltage mean shift 31 is performed on the multiplexor board to place the mean of the measured voltage to 2.5 V which falls in the middle of the ADC input voltage range. Using the applied DDS current as measured on the first ADC channel and electrode voltages measured on the second ADC channel, the microcontroller 16 can calculate the sensing skin's impedance based on amplitude measurements and the relative phase shift between the AC current and measured voltage.

The microcontroller board includes a set of header pins to accommodate the attachment of the wireless transceiver 12 that is on its own board (i.e., wireless radio board). The wireless transceiver 12 is a commercial radio: either a Maxstream 9XCite digital transceiver or a Texas Instruments CC2420 transceiver. The 9XCite radio operates on the 900 MHz radio band and is capable of data rates as high as 38.4 kbps and a line-of-sight communication range of 300 m. The radio 12 is controlled by the microcontroller 16 through a standard UART interface. On the other hand, the Texas Instruments CC2420 transceiver operates in the 2.4 GHz radio band and is capable of data rates as high as 250 kbps. In this case, a serial periphal interface (SPI) is used between the microcontroller 16 and transceiver for communication. It is readily understood that other types of wireless transceivers can be employed and interfaced in other manners (e.g., I2C) with the microcontroller.

In an exemplary arrangement, the radio board 2 is connected to a top side of the microcontroller board 4. The microcontroller board 4 is then attached to the DDS board 6 using a set of header pins. The multiplexer board 8 is attached to the microcontroller board 4 using flat flexible cables. A unique feature of the impedance analyzer 10 is that multiple multiplexor boards can be included in the assembled device to increase the number of channels. In the exemplary arrangement, two multiplexor boards 8 (16 channels each) are integrated with the impedance analyzer 10 to accommodate a total of 32 electrodes. One unique aspect of the design is that more or less multiplexor boards can be interfaced with the microcontroller in a modular manner to provide more or less electrodes. All connections to the substrate are made using shielded coaxial cables connected to SMA jacks. The coaxial cables contain an inner, grounded sheath that prevents noise from affecting the signals transmitted to and from the device. Each cable terminates in an alligator clip to facilitate connections to external electrodes although other types of cable terminations are also contemplated. The device can be powered by standard AC power from an electrical outlet or by a 7.5 volt battery pack. When fully assembled, the wireless impedance analyzer 10 is 10 cm long, 6 cm wide and 5 cm tall. The entire assembly may be placed in a common enclosure, thereby forming a portable device.

Further details for controlling the injection current in the exemplary embodiment are set forth below. Control over the DDS 14 is accomplished through a serial peripheral interface (SPI) which allows the microcontroller 16 to determine phase and frequency of the output. In the exemplary embodiment, the controller 16 writes to one of five registers in the DDS 14: a control register, 2 frequency registers and 2 phase registers. A prefix to the actual data bits determines which register is written to. The FSYNC, SCLK, and SDATA pins are used for the SPI operation. Data is sent to the DDS in 16-bit words via SDATA, under the control of the serial clock input (SCLK). FSYNC acts as a frame synchronization and chip enable in that data can only be transferred when FSYNC is low. After 16 ticks of SCLK, a word has been transmitted to the DDS and FSYNC is brought high. The 16 bit control register is loaded in a single word. It controls how frequency data is loaded, determines which frequency and phase register are selected, enables reset and sleep functions, and determines the output mode. The frequency registers are written by two consecutive words, the first containing the 14 LSBs and the second containing the 14 MSBs for a total of 28 bits. The 12 bit phase registers are written with a single word.

The desired frequency of the injection current output by the DDS is the product of an integrated oscillator, SIN ROM, and digital-to-analog converter. A clock signal input determines the rate of the output sinusoid:

$$f = {M}_{clk} * \frac{Freq}{{2}^{28}}$$

where M_{clk} is the input clock, chosen between a dedicated oscillator 32 and a clocked signal from the main board, and Freq is the value of the 28 bit register in the DDS. Assuming a dedicated 40 MHz oscillator is used for M_{clk}, the DDS 14 can output a sinusoid at a frequency between 0.149 Hz and 20 MHz at increments of 0.149 Hz.

Amplitude of the injection current is determined by two digital potentiometers 22, 23 that are incremented and decremented by the microcontroller 16. In an exemplary embodiment, the digital potentiometers (i.e., digipots) are 1 k and 100 k potentiometers with 100 increments of wiper resistance. The two digipots are coupled to an input of the DDS 14 but in parallel with each other. The amplitude of the injection current is determined by:

$$I = 18 * \frac{{V}_{ref}}{{R}_{set}}$$

where V_{ref} is 1.20V and Rₛₑₜ is determined by a base resistor in series with the two digipots. In this way, the microcontroller 16 can adjust the amplitude of the output current from the DDS. Other arrangements for adjusting the amplitude of the injection current are also contemplated by this disclosure.

Sensing skins is one exemplary application for the impedance analyzer 10. Skin is the largest human organ with a cellular design optimized to protect underlying tissue from the environment. In particular, skin is a multilayered system consisting of an outer epidermis layer, a thick inner dermis layer, and a subcutaneous layer. The outer epidermal layer is comprised of dead cells that are waterproof and designed to be mechanically robust to friction, tension, and shear. The dermis layer beneath is a sophisticated multi-layered system with a dense network of neural receptors that provide the skin with its sensing ability. Different receptor types exist within the dermis neural network to sense touch, temperature, and pain. Human skin is an ideal basis for bio-inspiration of new SHM sensing technologies for many reasons. First, skin is an impressive natural multifunctional material system optimized to offer incredible strength (to keep germs out of the body) while providing distributed sensing capabilities. The intricate neural network contained within the structure of the skin allows animals to detect the precise location and magnitude of stimuli (e.g., touch, heat) in real-time.

A bio-inspired skin system is proposed as a self-sensing coating for metallic structures. The objective of the sensing skin is to sense the response (i.e., strain) and deterioration (i.e., corrosion) of the underlying structural system upon which it is placed. Like all natural systems, skin is naturally fabricated based on a spontaneous self-assembly process that begins at the atomistic scale. For example, nature begins its assembly process with amino acids, which are small molecular structures that nature uses to assemble proteins. Protein molecules are then used to assemble sub-cellular components (e.g., organelles) that in turn are used to assemble cells. Cells then self-organize, reproduce, and form organs and other macro-scale functional elements that are found in all living beings. This self-assembly process is inherently a “bottom-up” approach, which consists of assembling increasingly complex structured systems from smaller functional blocks. Adopting a similar approach to bottom-up assembly of engineered materials has become possible with many of the recent advances in nanotechnology. The controlled assembly of smaller molecular structures to form complex molecular aggregates at the nano- and micro-scales offers unprecedented opportunities to achieve desired physical, electrical, and mechanical functionalities at the macro-scale.

In this study, a directed bottom-up assembly method known as layer-by-layer (LbL) is explored for the fabrication of thin film molecular structures that provide functionality similar to that of human skin. LbL deposition is a true bottom-up assembly method where supramolecules (i.e., polyelectrolyte species) are adsorbed onto the surface of a substrate through non-covalent or covalent atomic attractions. Motivation for the adoption of the LbL technique is due to the fact that this method is low-cost, creates highly homogenous composite materials, and does not require chemical modification of constituent materials. Furthermore, multi-layered thin films of varying thickness can be easily assembled to repeatedly depositing sets of oppositely charged mono-layers (i.e., bi-layers). Specifically, SWNT fillers included in an LbL-assembled poly(vinyl alcohol) (PVA)/poly(sodium 4-styrenesulfonate) (PSS) thin film will be explored to provide a basis for distributed, multi-modal sensing of physical phenomena pertinent to structural health monitoring applications. The LbL thin films are referred to as (SWNT-PSS/PVA)ₙ, where n is the number of bi-layers fabricated.

The conductivity of (SWNT-PSS/PVA)ₙ thin films have been shown to vary as a function of strain. This self-sensing attribute of the fabricated thin film can be leveraged to create strain sensors for SHM applications. However, if the conductivity of the entire thin film can be mapped, then the film can be utilized as a distributed sensor platform (i.e., sensing skin) that provides a spatial mapping of strain. To this end, electrical impedance tomography is adopted to provide a spatial mapping of sensing skin conductivity based on electrical measurements taken at the skin boundary. The application of EIT to determine changes in sensing skin spatial conductivity to strain, pH, and tears has been successfully demonstrated in previous studies with references.

EIT begins with an analytical model of the flow of electricity in a body (e.g., a multifunctional thin film) based on an input signal or the injection of a controlled current (either DC or AC) at two points on the body boundary. In general, a finite element method (FEM) model describing electrical flow in the body is formulated from the Laplace vector equation. In the forward problem, the distribution of body conductivity is known and the analytical model is used to predict the output electrical potential (i.e., voltage) on the boundary of the body due to the applied current. In contrast, EIT is an inverse problem in which the distribution of conductivity is unknown and is solved for using the known input (i.e., injected current) and output (i.e., the boundary electrical potential). Under one instance of current injection, the current-voltage data set is not sufficient for solving the underdetermined inverse problem. Rather, a redundant set of input-output data is necessary to render the EIT problem tractable. Hence, EIT necessitates stimulation of the body at multiple locations along the body boundary with corresponding electrical potential measured for each unique current injection.

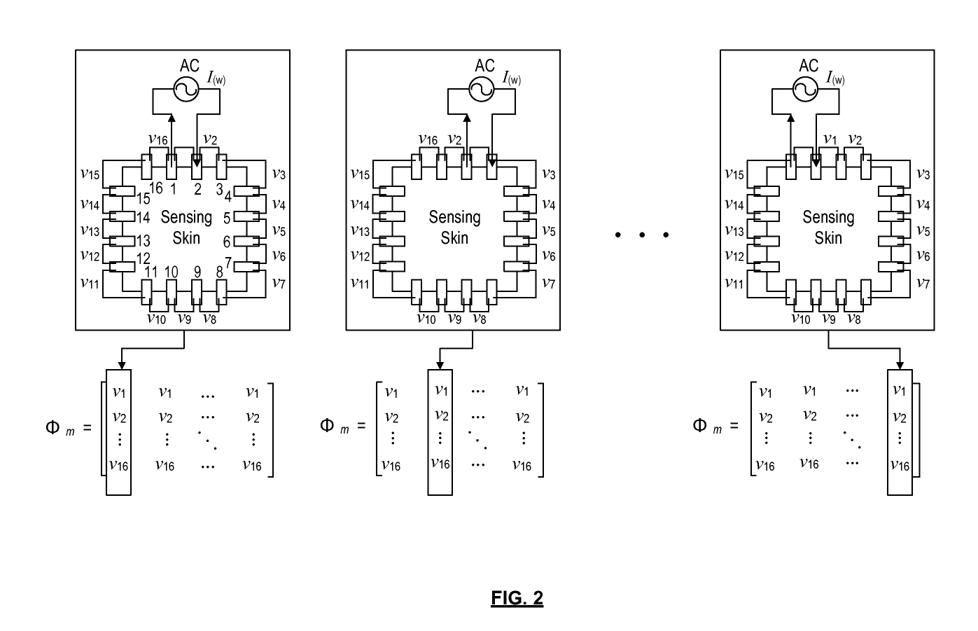

The general state-of-practice is to divide the boundary of the body into an equal number of segments with an electrode placed at the center of each segment. As shown in FIG. 2, the thin film has 16 electrodes placed equidistantly with four electrodes mounted on each side of the square film. The electrodes are numbered 1 through 16 as shown. First, the current is injected on the 1-2 electrode pair as illustrated in FIG. 2. If the injected current is a DC current, then the electric potentials, v, are measured on all of the boundary electrode pairs as shown in FIG. 2. If the injected current is an AC current, then the voltage amplitude and lag (phase shift relative to the input AC current) are measured. The measured electric potentials make up the first column of the electric potential matrix, Φ. Next, the current is applied to the 2-3 electrode pair with the boundary electric potential again measured. The measured potentials consist of the second column of the electric potential matrix, Φ. This process repeats until all adjacent electrode pairs have been used to stimulate the thin film. If done manually, this process can be extremely time-consuming, thereby ruling out the possibility of employing the sensing skin as an autonomous, real-time SHM system. Therefore, a portable wireless impedance analyzer is proposed to fully automate EIT data collection in the field setting.

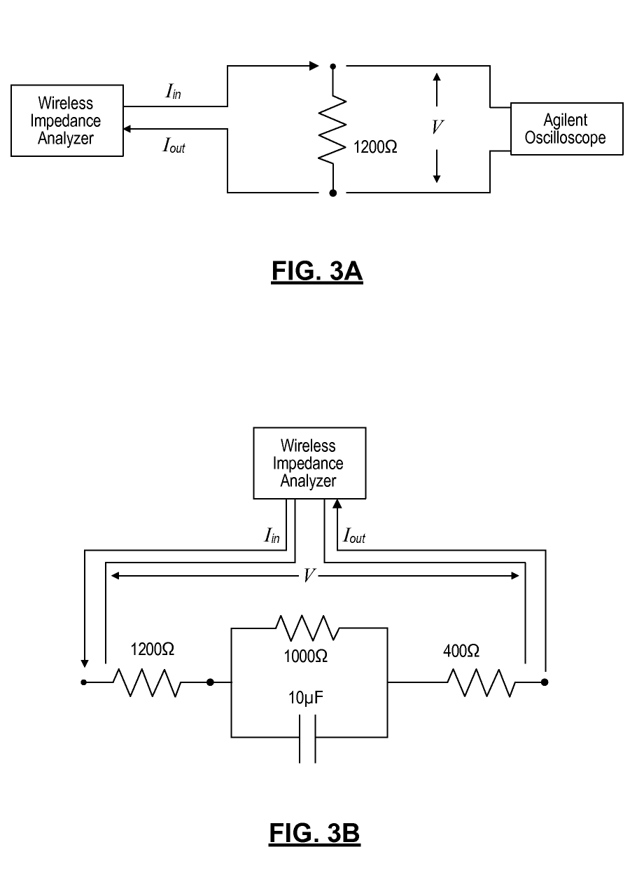

Two validation experiments are performed to verify the accuracy and reliability of the proposed wireless impedance analyzer as depicted in FIGS. 3A and 3B. In the first, the output of the DDS board is analyzed to ensure it is capable of outputting AC currents with precise amplitudes. The generated AC current is applied to a 1200Ω resistor, and the corresponding voltage is measured (FIG. 3A). In the second, electrical impedance spectroscopy (EIS) is conducted on a resistor-capacitor (RC) circuit using a four-point probe method (FIG. 3B). The EIS test will analyze the ability of the wireless impedance analyzer to output an AC current of varying frequency, capture the circuit voltage, and calculate complex-valued impedance.

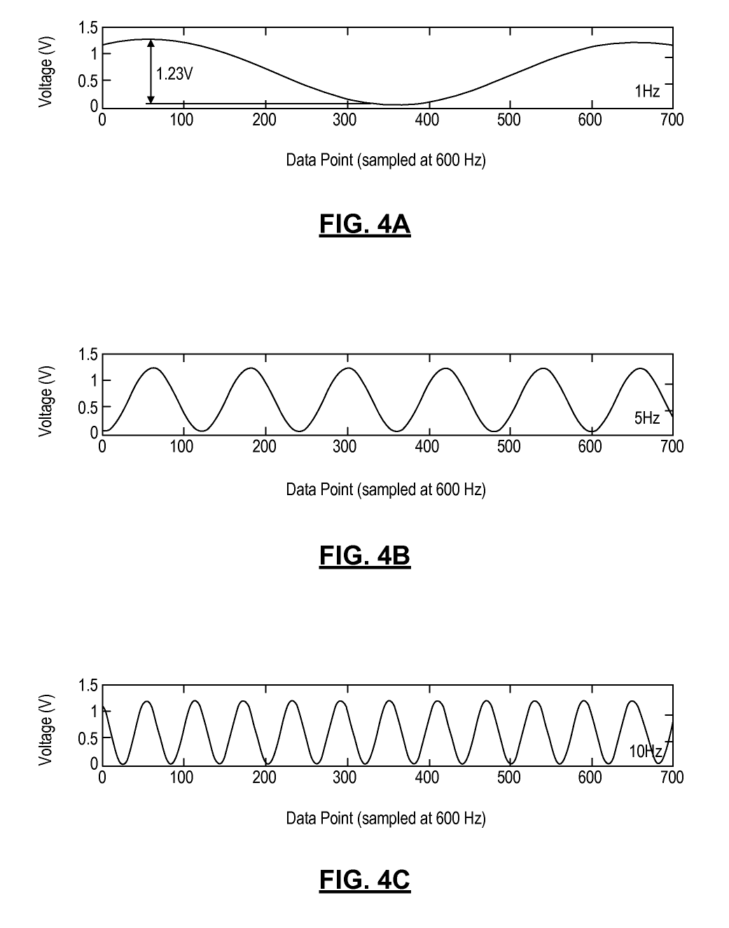

The DDS output of the wireless impedance analyzer is analyzed by generating an AC current applied to a 1.2 kΩ resistor as shown in FIG. 3A. The amplitude of the DDS board is configured to be 1 mA peak-to-peak with a non-zero mean. A separate Agilent data acquisition system is attached to the two terminals of the 1.2 kΩ resistor to record the resistor voltage at a 600 Hz sample rate. Using Ohm's Law, the current can be calculated based on the measured voltage. The measured voltage signals corresponding to three different AC frequencies (1, 5, and 10 Hz) are shown in FIGS. 4A, 4B and 4C respectively. As shown, the peak-to-peak voltage across the 1.2 kΩ resistor is 1.23 V and corresponds to 1.025 mA according to Ohm's Law. Furthermore, the AC frequencies are also measured from the voltage time histories to be that desired: 1, 5, and 10 Hz.

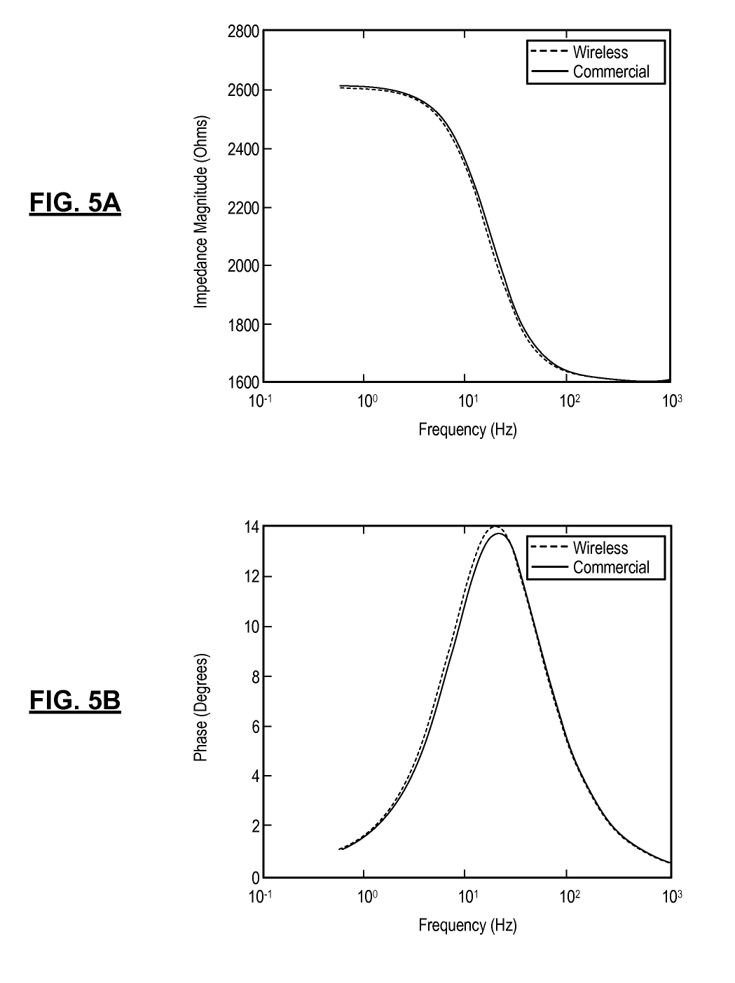

After verifying the accuracy of the DDS board, the ability of the wireless impedance analyzer to output AC currents of varying frequency and to simultaneously record voltage is assessed. Specifically, electrical impedance spectroscopy is performed on the RC circuit shown in FIG. 3B. The wireless impedance analyzer is configured to automatically apply a zero-mean AC signal (0.5 mA amplitude) with a frequency varying from 0.75 to 1000 Hz in increments of 0.15 Hz. At each frequency, the microcontroller board records both the applied AC signal and the corresponding voltage waveform. Using the peak amplitude of the measured voltage and the phase shift in the measured voltage relative to the AC current input, the impedance of the circuit is wirelessly transmitted by the relative to the AC current input, the impedance of the circuit is wirelessly transmitted by the wireless impedance analyzer. To verify the electrical impedance data collected by the prototype, the results are compared to impedance measurements taken by a commercial impedance analyzer (Solartron 1260 impedance-gain/phase analyzer) during an independent test on the same test circuit. FIGS. 5A and 5B shows that the results obtained by the prototype wireless impedance analyzer and the commercial impedance analyzer are in strong agreement. The impedance amplitudes are in perfect agreement with errors less than 1% between the wireless and commercial impedance analyzers. However, some minor disagreement in the impedance phase is identified with the wireless impedance analyzer error bounded by 4%. The inaccuracy in phase is attributed to minor parasitic capacitance within the unit's circuit design. While this capacitance can be eliminated in future device improvements, it can also be calculated and easily removed from the impedance measurements.

Most metallic structures that operate in harsh environments (e.g., aircraft, bridges, pipelines) are coated with sophisticated coating systems to prevent corrosion to the underlying metallic surface. For example, primers and corrosion-inhibiting layers are common within structural coating systems. While such systems have been proven effective, they are only effective if the coating itself remains undamaged. When the coating system is nicked or cut, the metallic surface is exposed and corrosion can occur. Assuming the aforementioned SWNT-PE thin film assembly is included in such a coating system for monitoring structural strain and cracking (Loh et al 2009a), this study explores the corrosion process that can occur on the metallic structural surface when openings in the sensing skin exists. Electrical impedance tomography is performed to analyze the process of corrosion formation within an accelerated corrosion test configuration.

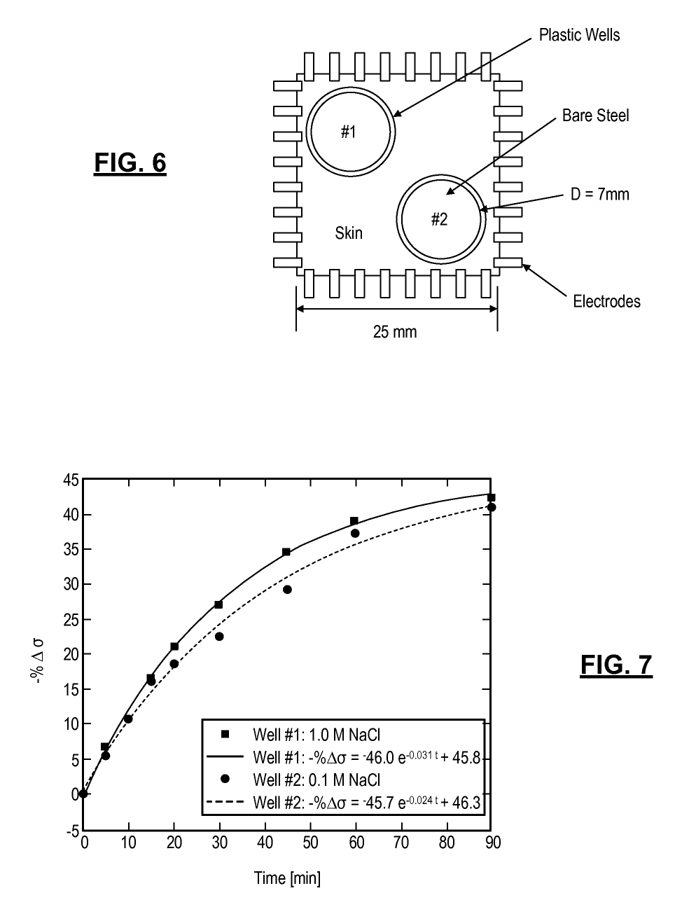

A carbon steel plate (25 mm wide, 55 mm long, 1.2 mm thick) is selected to serve as the substrate for the LbL assembly of the SWNT-PSS/PVA thin film. First, the surface of the carbon steel plate is treated with acetone and ethyl alcohol to rid its surface of impurities and oil. Second, the steel plate is coated with a thin coat of primer (Krypton General Purpose Primer) to ensure the underlying steel is electrically isolated from the SWNT-PE thin film assembly. After the primer has been permitted time to properly dry (72 hrs), the LbL process is initiated to form a 50 bi-layer thin film ((SWNT-PSS/PVA)₅₀). Upon film fabrication, eight conductive electrodes are formed along each side of the film boundary to form a total of 32 electrodes for the entire film. Each electrode is a thin slice of copper tape bonded to the sensing skin surface by silver paste. Once the silver paste on the electrodes has dried, the film and primer are mechanically etched on one side of the specimen to expose two 7 mm circular regions of the bare carbon steel substrate. Finally, a plastic well is then secured over the exposed circular holes using high-vacuum grease (schematic and photograph of a specimen are shown in FIG. 6). A coaxial wire is attached to each electrode using an alligator clip with each of the 32 coaxial wires terminated at the impedance analyzer multiplexor board. The coaxial cables contain an inner signal line and a grounded sheath that prevents noise from affecting the signals transmitted over the cable.

Accelerated corrosion of the exposed carbon steel region is conducted by pipetting into plastic wells #1 and #2 0.1 M and 1.0 M sodium chloride solutions, respectively. These plastic wells are used to confine salt solutions to the selectively etched areas and to promote corrosion and rust formation at the two circular regions; the plastic wells also serve to prevent the solutions from wetting other regions of the film. It is known that corrosion of steel occurs due to the oxidation of iron (within the steel) to form iron oxide (i.e., rust) (Ahmad 2003)

3Fe+4H₂O→Fe₃O₄+8H⁺+8e⁻ (1a)

2Fe=3H₂O→Fe₂O₃+6H⁺+6e⁻ (1b)

When water is available for the oxidation of iron, the reaction kinetics highly favors the formation of iron oxide. As a result, with increased water exposure time, rust will continue to form as long as the chemical reaction is not rate-limited by iron availability.

For this validation study, the NaCl solutions are initially pipetted into the plastic wells for 5 min (herein referred to as the “corrosion time”) and subsequently removed. Then, the specimens are allowed sufficient time to dry (1 hr) prior to EIT spatial conductivity mapping. The EIT boundary potential is measured. This procedure completes one sensing skin measurement corresponding to 5 min of corrosion time. Then, fresh 0.1 M and 1.0 M NaCl solutions are again pipetted into the plastic wells for another 5 min; the procedure is repeated until a total corrosion time of 90 min has occurred.

Upon etching the sensing skin to expose two circular regions of the bare steel substrate, an initial EIT spatial conductivity map is obtained to serve as the undamaged baseline. For EIT mapping, an AC current (0.1 mA) with zero mean and 100 Hz frequency is used. Then, following the experimental details previously outlined, successive time-lapsed EIT maps are acquired for each corrosion time to monitor the corrosion byproduct formation that results from concentrated sodium chloride solution exposure. The actual EIT algorithm is performed off-line using a standard personal computer.

Sensing skin spatial conductivity maps (i.e., relative to the baseline) and the corresponding photographs were taken at various corrosion times ranging from 5 to 90 min. It can be observed that the skin's electrical conductivity in the vicinity of the wells decrease as corrosion time increases. The localized decrease in conductivity corresponds to increasing rust (or iron oxide) formation on the exposed steel surfaces, as is also confirmed by the time-lapsed photographs. On the other hand, regions outside of the wells that have not been exposed to salt solutions remain in their pristine state (i.e., no corrosion) throughout the duration of the test. Similarly, the EIT spatial conductivity maps also indicate that the change in conductivity at regions outside the well are insignificant and are approximately zero. Thus, these results provide evidence that the carbon nanotube sensing skins employed in this study show potential for spatial corrosion monitoring when tears and breaks in the sensing skin occurs.

After initially removing the sensing skin and primer at the well locations, the Baseline EIT conductivity map (i.e., pre-corrosion) reveals that the etched regions possess low electrical conductivity and is significantly less conductive than the thin film. As corrosion takes place and thin layers of electrically insulating iron oxides form on the steel substrate, the conductivity at the corroded site electrically insulating iron oxides form on the steel substrate, the conductivity at the corroded site should decrease. This hypothesis is consistent with the experimental findings. When the average negative change in conductivity at wells #1 and #2 are plotted as a function of corrosion time, an exponential decrease in well conductivity is obtained as shown in FIG. 7. With increasing salt solution exposure time, the average negative conductivity change for both wells #1 (1.0 M NaCl solution) and #2 (0.1 M NaCl solution) following the same trend; initially, a sudden drop in conductivity is observed, followed by a decreasing rate until it plateaus at t=90 min. The plateau effect is due to the fact that the area of bare steel (or iron availability) decreases with increasing iron oxidation and rust formation. The results obtained in FIG. 7 agree with those obtained by Yonemoto and Shida (1998) where they have determined that their proposed corrosion sensor's impedance increases in a similar fashion with increasing rust thickness. In fact, the experimental results obtained in FIG. 7 can be easily fit to an exponential decay model of the form −Δσ=−Ae^{-Bt}+C via regression analysis. Results from numerical fitting suggest that the average change in thin film conductivity due to corrosion byproduct formation is well-behaved. The nanocomposite conductivity decreases at an exponential rate of 0.031 min⁻¹ for well #1 (1.0 M NaCl) and 0.024 min⁻¹ for well #2 (0.1 M NaCl). The faster corrosion rate for well #1 is consistent with the higher concentration of salt solution employed during testing.

In previous studies, it has already been shown that carbon nanotube-based thin films change their electrical properties in response to applied strain of pH. Unlike traditional sensors based on data measurements at a discrete point, these thin films can be employed as a distributed sensor platform (or sensing skin). Electrical impedance tomography utilizes boundary electrical measurements for mapping thin film spatial conductivity; however, due to the complexity of the EIT inverse problem, multiple sets of boundary current injection and potential measurements are required. Realization of a real-time and autonomous SHM system demands an alternative solution for rapid automated EIT data collection. Thus, a wireless impedance analyzer is designed and proposed for automated impedance measurements and for the acquisition of electrical impedance tomography data. Unlike other wireless impedance analyzers, the user can selectively output an electrical current of controlled amplitude and frequency (i.e., from near-DC to 20 MHz) at any one of its 32 independently addressable channels, while the device samples voltage at the remaining electrodes. All the measurements are controlled by a lower-power 8-bit microcontroller, and its internal 10-bit ADC digitizes the acquired data. The data collected can be stored in an onboard 128 kB SRAM, but data communication to a centralized data repository is ultimately achieved with a Maxstream 9XCite wireless transceiver integrated with the device hardware. The fully assembled unit is 10 cm long, 6 cm wide, and 5 cm tall and can draw its power from an AC electrical source or from a 7.5 V battery pack.

Upon hardware implementation, three tests have been performed to validate the wireless impedance analyzer's impedance and EIT data acquisition performance. First, the device is commanded to interrogate a 1.2 kΩ resistor using 1 mA AC current outputs at three different AC frequencies (1, 5, and 10 Hz), while the voltage response is measured by the wireless impedance analyzer is capable of generating electrical signals at prescribed amplitudes and frequencies. For the second test, the wireless impedance analyzer is connected to an RC circuit for conducting electrical impedance spectroscopy. The device applies a zero-mean AC signal from 0.75 to 1000 Hz while the corresponding voltage magnitude and phase is recorded at each applied AC frequency for computing the impedance of the RC circuit. When compared to the results obtained by a commercial Solartron 1260 impedance analyzer, good agreement and low measurement errors are confirmed. Finally, electrical impedance tomography is employed for spatial conductivity mapping of a (SWNT-PSS/PVA)₅₀ thin film deposited onto a primer-coated steel plate. The objective is to identify localized changes in thin film conductivity when concentrated salt solutions accelerate corrosion and rust formation at exposed metallic structural surface areas. It has been shown that the EIT spatial conductivity maps show localized decreases in conductivity corresponding to rust (or iron oxide) formation. On the other hand, the sensing skin's conductivity remains fairly constant at other locations where there is no corrosion activity. Thus, these results validate the use of EIT for mapping thin film spatial conductivity; and the wireless impedance analyzer provides a more cost effective and rapid method for EIT data acquisition.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A portable wireless impedance analyzer, comprising:
a direct digital synthesizer configured to receive input parameters and operable to generate an injection signal in accordance with the input parameters;
a wireless transceiver configured to receive user commands over a wireless data link and to transmit data back to the user;
a microcontroller interfaced with the wireless transceiver and the direct digital synthesizer, the microcontroller is operable to translate the user commands into one or more input parameters for the direct digital synthesizer and communicate the input parameters to the direct digital synthesizer, where the wireless transceiver, the direct digital synthesizer and the microcontroller reside in a portable housing.

2. The impedance analyzer of claim 1 further comprises a multiplexer having a data input, a selector input and a plurality of outputs, the multiplexer configured to receive the injection signal via the data input from the direct digital synthesizer and route the injection signal to one of the plurality of outputs, wherein the microcontroller is interfaced via the selector input with the multiplexer to select one of the plurality of outputs from which to output the injection current.

3. The impedance analyzer of claim 2 further comprises a current source interposed between the direct digital synthesizer and the output multiplexer and operable to generate the injection current.

4. The impedance analyzer of claim 1 further comprises a demultiplexer having a plurality of inputs, a data output and a data selector, the demultiplexer is configured to receiving voltage measures at the plurality of inputs and output a selected voltage measure to the microcontroller, wherein the microcontroller is interfaced via the data selector with the demultiplexer to select one of the plurality of inputs which to receive a voltage measure.

5. The impedance analyzer of claim 4 further comprises a shifter circuit interposed between the demultiplexer and the microcontroller and operable to scale and mean shift the voltage measure received from the demultiplexer.

6. The impedance analyzer of claim 1 wherein the direct digital synthesizer having an input to set a desired frequency for the injection signal and the microcontroller receives a user command that specifies a desired frequency for the injection signal and outputs a corresponding control signal to the input of the direct digital synthesizer.

7. A portable wireless impedance analyzer, comprising:
a wireless transceiver configured to receive user commands over a wireless data link;
a direct digital synthesizer configured to receive an input parameter that specifies a desired frequency for an injection signal and generates an injection signal having a sinusoidal waveform at the desired frequency in accordance with the input parameter;
a current source configured to receive the injection signal and generate an injection current in accordance with the injection signal; and
a microcontroller configured to receive the user commands from the wireless transceiver and operable to translate the user commands into one or more input parameters for the direct digital synthesizer and communicate the input parameters to the direct digital synthesizer;
wherein the direct digital synthesizer is further configured to receive an input from a user actuated potentiometer and control amplitude of the injection signal in accordance with the input from the potentiometer.

8. The impedance analyzer of claim 7 further comprises a demultiplexer configured to receive two or more different types of injection signals from the direct digital synthesizer and output one of the injection signals to the current source in accordance with a control signal received from the microcontroller.

9. The impedance analyzer of claim 7 wherein the current source is further defined as a Howland circuit.

10. The impedance analyzer of claim 7 wherein the wireless transceiver is interfaced via a universal asynchronous receiver transmitter or serial peripheral interface with the microcontroller.

11. The impedance analyzer of claim 7 wherein the microcontroller communicates the input parameters via a serial peripheral interface to the direct digital synthesizer.

12. The impedance analyzer of claim 7 further comprises a multiplexer having a data input, a selector input and a plurality of outputs, the multiplexer configured to receive the injection signal via the data input from the direct digital synthesizer and route the injection signal to one of the plurality of outputs, wherein the microcontroller is interfaced via the selector input with the multiplexer to select one of the plurality of outputs from which to output the injection current.

13. The impedance analyzer of claim 7 further comprises a demultiplexer having a plurality of inputs, a data output and a data selector, the demultiplexer is configured to receiving voltage measures at the plurality of inputs and output a selected voltage measure to the microcontroller, wherein the microcontroller is interfaced via the data selector with the demultiplexer to select one of the plurality of inputs which to receive a voltage measure.

14. A portable wireless impedance analyzer, comprising:
a wireless transceiver configured to receive user commands over a wireless data link;
a direct digital synthesizer configured to receive input parameters and operable to generate an injection signal in accordance with the input parameters;
a microcontroller configured to receive the user commands from the wireless transceiver and operable to translate the user commands into one or more input parameters for the direct digital synthesizer and communicate the input parameters to the direct digital synthesizer;
a multiplexer having a data input, a selector input and a plurality of outputs, the multiplexer configured to receive the injection signal via the data input from the direct digital synthesizer and route the injection signal to one of the plurality of outputs, wherein the microcontroller is interfaced via the selector input with the multiplexer to select one of the plurality of outputs from which to output the injection current; and
a demultiplexer having a plurality of inputs, a data output and a data selector, the demultiplexer is configured to receiving voltage measures at the plurality of inputs and output a selected voltage measure to the microcontroller, wherein the microcontroller is interfaced via the data selector with the demultiplexer to select one of the plurality of inputs which to receive a voltage measure.

15. The impedance analyzer of claim 14 wherein the microcontroller having a first analog-to-digital converter configured to receive the injection current and a second analog-to-digital converter configured to receive the selected voltage measure from the demultiplexer and operable to calculate a phase difference between the injection current and the selected voltage measure.

16. The impedance analyzer of claim 14 wherein the microcontroller is further operable to calculate an impedance for a test subject from the voltage measures received by the demultiplexer and the corresponding phase differences.

17. The impedance analyzer of claim 14 further comprises a second multiplexer configured to receive the injection signal from the direct digital synthesizer and route the injection signal to one of a plurality of outputs, wherein the microcontroller is interfaced with the second multiplexer to select one of the plurality of outputs from which to output the injection current.

18. The impedance analyzer of claim 14 further comprises a second demultiplexer configured to receiving voltage measures at a plurality of inputs and output a selected voltage measure to the microcontroller, wherein the microcontroller is interfaced with the second demultiplexer to select one of the plurality of inputs which to receive a voltage measure.

19. The impedance analyzer of claim 14 wherein the direct digital synthesizer configured to receive an input parameter that specifies a desired frequency for an injection signal and generates an injection signal having a sinusoidal waveform at the desired frequency in accordance with the input parameter.

20. The impedance analyzer of claim 19 wherein the direct digital synthesizer is further configured to receive an input from a user actuated potentiometer and control amplitude of the injection signal in accordance with the input from the potentiometer.
